(19) United States
(12) Patent Application Publication
(10) Pub. No.: US 2007/0151114 A1
(43) Pub. Date: Jul. 5, 2007

(54) HAND-GUIDED POWER TOOL ROTATING KNOB ADJUSTING DEVICE

(76) Inventors: Gabor Papp, Miskolc (HU); Jozsef Dudas, Emoed (HU)

Correspondence Address: Striker, Striker & Stenby, 103 East Neck Road, Huntington, NY, 11743, US

(21) Appl. No.: 11/616,096

(22) Filed: Dec. 26, 2006

(30) Foreign Application Priority Data
Dec. 30, 2005 (DE) 102005063016.2

(51) Int. Cl. B27C 1/10

(52) U.S. Cl. 30/475

(57) ABSTRACT

A hand-guided power tool having a rotating knob adjusting device provided with a knob part and rotatable between at least two adjustment positions spaced apart from each other in a circumferential direction, and means for securing the rotating knob adjusting device against an inadvertent rotation.

### CROSS-REFERENCE TO A RELATED APPLICATION

The invention described and claimed hereinbelow is also described in German Patent Application DE 10 2005 063 016.2 filed on Dec. 30, 2005. This German Patent Application, whose subject matter is incorporated here by reference, provides the basis for a claim of priority of invention under 35 U.S.C. 119(a)-(d).

### BACKGROUND OF THE INVENTION

The invention relates to a hand-guided power tool with a rotating knob adjusting device.

Hand-guided power tools of this kind are known in an extremely wide variety of forms. All of the known hand-guided power tools share the common trait that the rotating knob adjusting device on the one hand serves as a grip for absorbing guidance and holding forces during operation of the hand-guided power tool and on the other hand, serves as an adjusting device, for example for changing the operating state of the hand-guided power tool or for adjusting the position of the in particular rotating tool of the hand-guided power tool.

DE 102 25 622 A1 has disclosed a hand-guided power planer with a rotating knob adjusting device. The rotating knob adjusting device on the one hand, functions as an auxiliary grip for guiding the hand-guided power planer and on the other hand, functions as an adjusting device for changing the cutting depth of the hand-guided power planer. While maneuvering the hand-guided power tool, the user occasionally exerts powerful forces on the rotating knob adjusting device. This results in the possibility of an unintentional actuation of the rotating knob adjusting device and change in the cutting depth, particularly when the hand-guided power planer is being guided around an obstacle. This can result in damage to the work piece being machined.

### SUMMARY OF THE INVENTION

The object of the invention is to disclose a hand-guided power tool embodied in such a way that minimizes the risk of an unintentional damage to the work piece being machined.

In keeping with these objects and with others which will become apparent hereinafter, one feature of the present invention resides, briefly stated, in a hand-guided power tool, comprising a rotating knob adjusting device provided with a knob part and rotatable between at least two adjustment positions spaced apart from each other in a circumferential direction; and means for securing said rotating knob adjusting device against an inadvertent rotation.

The invention is based on the concept of embodying the rotating knob adjusting device so as to avoid an unintentional rotation of the rotating knob adjusting device. The maneuvering forces exerted on the knob part of the rotating knob adjusting device, no matter how powerful, do not produce an adjustment without an additional action by the user. Only when the user enables rotation of the rotating knob adjusting device is it possible to change the adjustment position. This advantageously avoids inadvertent damage to the work piece being machined.

According to a preferred embodiment of the hand-guided power tool according to the invention, the knob part can only be rotated together with an actuating rod—to this end, the knob part is joined to the actuating rod in non-rotating fashion. The actual adjustment is executed by means of the actuating rod, for example the actuation of electrical contacts or the position change of the tool, in particular the change of the cutting depth of a power planer. In order to secure the rotating knob adjusting device against an inadvertent rotation, a locking element is provided, which is part of the rotating knob adjusting device. As a result, aside from the rotating knob adjusting device, it is not necessary to provide any additional moving parts in order to fix the rotating knob adjusting device in position. The locking element can be moved in the axial direction relative to the actuating rod and relative to the knob part that is connected to the actuating rod in non-rotating fashion, between a locked position in which the rotating knob adjusting device cannot be rotated, and a released position in which the rotating knob adjusting device is able to rotate.

In a modification of the invention, in its locked position, the locking element is advantageously connected in a form-locked fashion to a component of the hand-guided power tool, in particular the housing. The form-locked engagement is released by sliding the locking element axially along the actuating rod.

It is useful for the locking element to have a grasping section that the user can grasp in order to slide the locking element in the axial direction. It is advantageous if the locking element, when it is being moved from its locked position into the released position, can be moved axially toward the knob part of the rotating knob adjusting device. During operation of the hand-guided power tool, as a rule, the user rests the palm of one hand on the knob part of the rotating knob adjusting device. The user can grasp the grasping section of the locking element with an index finger and/or middle finger and conveniently pull the locking element, i.e. in the direction toward the knob part.

This axial movement releases the form-locked engagement between the locking element and the housing component, thus permitting a joint rotation of the knob part and the actuating rod, provided that the locking element is in its released position. The above-described arrangement of the locking element prevents an inadvertent sliding of the locking device and thus prevents an inadvertent release of the locking mechanism since during operation of the hand-guided power tool, the primary forces exerted on the knob part are compressive forces and not the tensile forces required to adjust the locking mechanism.

Preferably, the locking element has an extension that is accommodated in a recess of the housing of the hand-guided power tool in the locked position. In other words, the extension of the locking element engages with the housing in detent fashion. According to the invention, each possible adjustment position is associated with a recess for fixing the extension of the locking element in position. If the rotary knob adjusting device is used to adjust the cutting depth, for example, then this adjusting action occurs in many small steps. In this case, a large number of recesses is provided, which are situated next to one another in the circumference direction, e.g. forming a sort of ring gear.

The hand-guided power tool is particularly convenient to operate if the adjusting movement of the locking element from the locked position into the released position occurs counter to the force of a spring. If the locking element is released after an adjusting movement, then the spring force of the spring automatically locks the rotating knob adjusting device once more.

According to a modification of the invention, the locking element is connected to the actuating rod in a non-rotating fashion so that the knob part, the actuating rod, and the locking device are always only able to rotate jointly.

According to a particularly preferable embodiment variant, the actuating rod passes through the locking element. In this case, the knob part of the rotating knob adjusting device can be embodied in the form of an adjusting knob, spaced axially apart from which is situated the cross-sectionally annular locking element.

A particularly easy-to-mount rotating knob adjusting device is obtained if the knob part is embodied so that it can engage in detent fashion with the actuating rod.

In order to prevent dirt particles, in particular planer shavings, from getting into the housing, the knob part and locking element overlap each other axially in both the locked position and the released position.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a hand-guided power planer in accordance with the present invention,

FIG. 2 is a perspective view of a rotating knob adjusting device in which the knob part is shown spaced axially apart from the actuating rod for the sake of visibility in accordance with the present invention,

FIG. 3 shows the rotating knob adjusting device in the installed position in accordance with the present invention, and

FIG. 4 shows a longitudinal section through the rotating knob adjusting device in accordance with the present invention.

### DESCRIPTION OF THE PREFERRED EMBODIMENTS

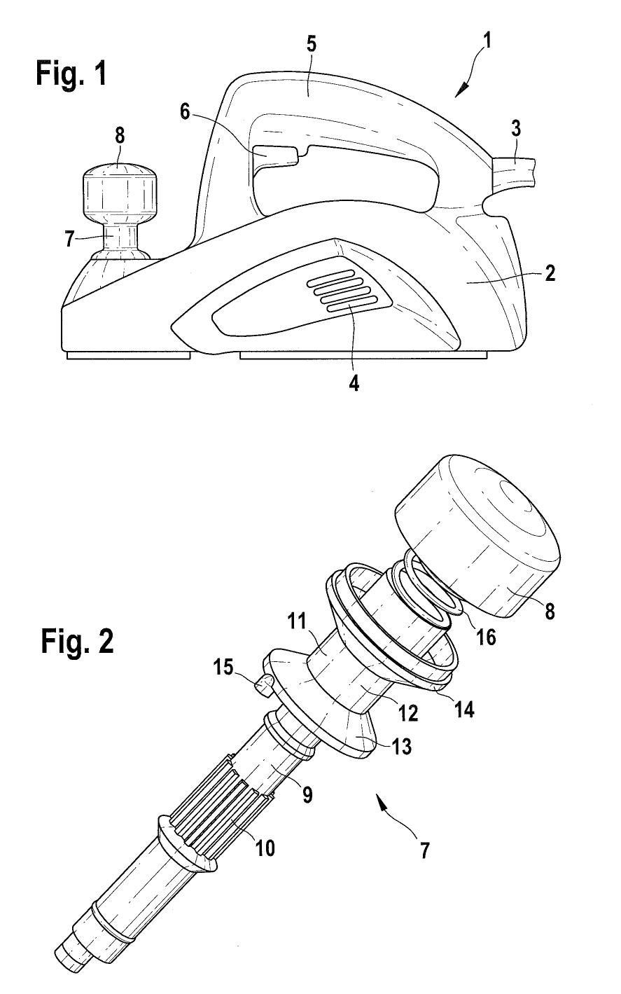

The hand-guided power planer 1 shown in FIG. 1 has a plastic housing 2. The hand-guided power planer 1 is provided with electrical energy via a cable 3. A drive motor, not shown, is contained inside the housing 2 and is provided to drive a planing shaft that is also not shown. The waste heat from the motor is transported out of the housing 2 via lateral ventilation slots 4. The hand-guided power planer 1 has a handle 5 with a trigger switch 6 for switching the motor on and off. In the front region of the hand-guided power planer 1, there is a rotating knob adjusting device 7 with a knob part 8. The rotating knob adjusting device 7 serves on the one hand as an auxiliary handle for guiding the hand-guided power planer 1 and on the other hand for setting the cutting depth, i.e. to adjust the position, of the planning shaft, not shown.

FIG. 2 shows the rotating knob adjusting device 7 as an uninstalled subassembly. For the sake of visibility, the knob part 8 is shown axially offset toward the outside in comparison to its installed position. When in the installed position, the knob part 8 engages in detent fashion with an actuating rod 9. The actuating rod 9 has an axial gearing 10 that can be used to change the position of the planing shaft, not shown. A locking element 11 is situated coaxially in relation to the actuating rod 9. This locking element is connected to the actuating rod 9 in a non-rotating fashion and can be slid axially in relation to the actuating rod 9.

The locking element 11 is comprised of a central, cylindrical section 12 as well as a lower cap-shaped section 13 and, spaced axially apart from this, an upper cap-shaped section 14. The lower cap-shaped section 13 has an extension 15 protruding in the axial direction. This extension, as will be explained in detail later, serves to produce a form-locked connection with the housing 2. To this end, the locking element 11 must be slid counter for the force of a helical spring 16 out of its locked position into its released position and therefore in the direction toward the knob part 8.

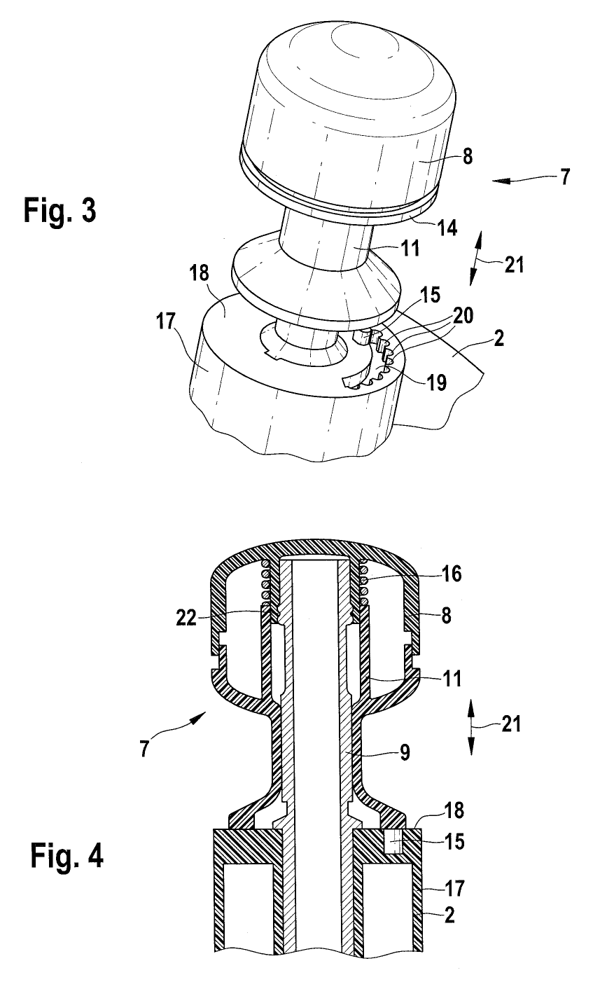

FIG. 3 shows the rotating knob adjusting device in the installed position. In this position, most of the actuating rod 9 is accommodated inside the housing 2, partially inside a cylindrical section 17. At the top end 18 of the cylindrical section 17 of the housing 2, a hollow 19 is provided, which is the shape of a partial circle and is provided with a number of radial recesses 20. The recesses 20 constitute a type of ring gear. The extension 15 of the locking element 11 can be accommodated in the recesses 20, making it possible to produce a form-locked engagement between the housing 2 and the locking element 11—and therefore the rotating knob adjusting device 7.

In FIG. 3, the locking element 11 is shown in its released position, i.e. offset axially in the direction toward the knob part 8. In this position, the extension 15 does not engage with the recesses 20, thus permitting the knob part 8 to move jointly with the actuating rod 9 and the locking element 11 in the circumference direction. The locking element 11 can be easily moved into the released position shown in FIG. 3 and held there. To this end, the locking element 11 has the cap-shaped section 13, whose underside serves as a grasping section. In FIG. 3, the distance between the locking element 11 and the top end 18 of the housing 2 is depicted in an exaggerated fashion. It is sufficient for the maximum movement play of the locking element 11 in the arrow direction 21 to be a few millimeters, for example a maximum of numeral 3 mm.

In FIG. 4, the rotating knob adjusting device 7 is depicted in a sectional view. In it, the locking element 11 is situated in its locked position and is resting against the top end 18 of the cylindrical section 17 of the housing 2. The extension 15 is engaged in detent fashion with recesses 20, not shown, of the housing 2. The drawing shows the helical spring 16, one end of which rests against the knob part 8, which is connected to the actuating rod 9 in non-rotating fashion, and the other end of which rests against the locking element 11. In FIG. 4, it is clear that the knob part 8 overlaps the locking element 11 in the axial direction. This prevents dirt particles from getting into the housing, particularly into the region between the knob part 8 and the locking element 11.

FIG. 4 also shows the detent mechanism 22 by means of which the knob part 8 engages with the actuating rod 9 in detent fashion.

It will be understood that each of the elements described above, or two or more together, may also find a useful application in other types of constructions differing from the type described above.

While the invention has been illustrated and described as embodied in a hand-guided power tool with rotating knob adjusting device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hand-guided power tool, comprising a rotating knob adjusting device provided with a knob part and rotatable between at least two adjustment positions spaced apart from each other in a circumferential direction; and means for securing said rotating knob adjusting device against an inadvertent rotation.

2. A hand-guided power tool as defined in claim 1; and further comprising an actuating rod to which said knob part is joined in non-rotating fashion, and a locking element movable in an axial direction along said actuating rod and relative to said knob part between a locked position and a released position.

3. A hand-guided power tool as defined in claim 2, wherein said locking element is configured so that in the locked position it engages in a form-locking fashion with a component of the hand-guided power tool.

4. A hand-guided power tool as defined in claim 3; and further comprising a housing forming said component, so that in the locked position said locking element engages in a form-locked fashion with said housing.

5. A hand-guided power tool as defined in claim 2, wherein said locking element has a grasping section and, as it is being moved from the locked position into the release position, said locking element is movable axially toward said knob part.

6. A hand-guided power tool as defined in claim 2; and further comprising a housing having a recess, said locking element having an extension which in the locked position is accommodated in said recess of said housing, so that each adjustment position is associated with at least one said recess.

7. A hand-guided power tool as defined in claim 6, wherein said housing has a cylindrical portion provided inside with said recess, so that said extension of said locking element in the locked position is accommodated in said recess inside said cylindrical section of said housing.

8. A hand-guided power tool as defined in claim 2; and further comprising a spring, said locking element being arranged so that an adjusting movement of said locking element from the locked position to the released position is executed counter to a force of said spring.

9. A hand-guided power tool as defined in claim 2, wherein said locking element is non-rotatably connected to said actuating rod.

10. A hand-guided power tool as defined in claim 2, wherein said actuating rod passes through said locking element.

11. A hand-guided power tool as defined in claim 2 wherein said knob part engages with said actuating rod in detent fashion.

12. A hand-guided power tool as defined in claim 2, wherein said knob part and said locking element overlap each other axially in both the locked position and the released position.

13. A hand-guided power tool as defined in claim 1, wherein the hand-guided power tool is configured as a hand-guided power planer.
